(19) United States
(12) Patent Application Publication
(10) Pub. No.: US 2021/0350159 A1
(43) Pub. Date: Nov. 11, 2021

(54) IMAGING DEVICE AND IMAGING SYSTEM

(71) Applicant: KONICA MINOLTA, INC., Tokyo (JP)

(72) Inventors: Motoki KANZAWA, Tokyo (JP); Munehiro NAKATANI, Toyohashi-shi (JP)

(73) Assignee: KONICA MINOLTA, INC., Tokyo (JP)

(21) Appl. No.: 17/221,922

(22) Filed: Apr. 5, 2021

(30) Foreign Application Priority Data
May 8, 2020 (JP) 2020-082334

(51) Int. Cl. G06K 9/20; G06K 9/00; G06T 7/70; G06K 9/78

(52) U.S. Cl. CPC G06K 9/2054; G06K 9/0063; G06K 2209/21; G06K 9/78; G06T 7/70

(57) ABSTRACT

An imaging device is mounted on or built into a moving body, and the imaging device includes: a camera that captures an image of surroundings of the moving body; an image processing part that processes an image captured by the camera; and a post-processing part that transmits or records an image processed by the image processing part, wherein the image processing part detects personal information contained in an image captured by the camera, and performs image processing for disabling determination of the personal information.

The entire disclosure of Japanese patent Application No. 2020-082334, filed on May 8, 2020, is incorporated herein by reference in its entirety.

### BACKGROUND

### Technological Field

The present invention relates to an imaging device and an imaging system.

### Description of the Related art

In recent years, image-capturing has been performed from the sky by mounting a camera on a flying body called a drone. Drone flight is currently subject to some restrictions in many countries. For example, in Japan, aviation law prohibits drone flight in densely populated areas. However, if the safety of drone flight is ensured in the future, it is highly likely that the restrictions will be relaxed and drone flight will be permitted in densely populated areas.

Meanwhile, since a camera mounted on the drone captures an image from the sky, there is a possibility that the captured image contains personal information that is not to be imaged when the image is captured from the ground. Therefore, for an image captured by a camera mounted on a drone, a personal information protection function different from that of a general camera is required. For example, a veranda of a house hidden from a road side by a fence and windows on the second and higher floors are portions originally invisible from the ground, and it is not desirable to capture an image of these parts.

In addition to flying bodies such as drones, as an example in which the privacy of captured images becomes a problem, there is a dashboard camera mounted on an automobile traveling on a road. Even for the dashboard camera, protection of personal information contained in captured images has become a problem. That is, images captured by the dashboard camera often contain personal information such as a face of a person or a nameplate of a building, which can be a problem if the captured image is published.

Conventionally, when images captured by a drone or a dashboard camera are published on a network or broadcasting, the images have been published after being subjected to editing work such as applying a mosaic to a portion containing personal information in the image.

JP 2016-119628 A describes a technique of wirelessly transmitting a monitor image taken by an airship from the airship to a center device, and converting to low resolution images and the like to maintain privacy in an image processing apparatus installed in the center device.

As described in JP 2016-119628 A, it has been conventionally known to process an image captured by a flying body for privacy protection. However, it may not be possible to properly protect personal information even if this technique is applied to the above-mentioned drone as it is. That is, normally, the image captured by the camera mounted on the drone is wirelessly transmitted to a controller that operates the drone, and recorded in a memory or the like in the controller.

Here, by incorporating the image processing apparatus described in JP 2016-119628 A into the controller, a recorded image with privacy protection is to be obtained.

However, if an image signal wirelessly transmitted from the drone is illicitly received by another device, the image signal is not subjected to image processing for privacy protection. This may result in leakage of an image without protection of personal information.

Of course, it is possible to encrypt the image signal to inhibit unauthorized reception during wireless transmission from the drone to the controller, but it is not uncommon for the encryption to be broken.

In addition, the image captured by the drone needs to be monitored by an operator in real time on the controller side, in order to operate flight of the drone. Therefore, it is necessary that the image captured by the drone does not require much time for encryption and decryption, and very strong encryption is not desirable.

Even for a dashboard camera for an automobile, it is common to perform image processing for privacy protection when using an image recorded with the dashboard camera. Therefore, privacy protection is usually not considered when images are recorded on the dashboard camera.

### SUMMARY

In view of these points, it is an object of the present invention to provide an imaging device and an imaging system that can appropriately protect personal information of captured images.

To achieve the abovementioned object, according to an aspect of the present invention, there is provided an imaging device mounted on or built into a moving body, and the imaging device reflecting one aspect of the present invention comprises: a camera that captures an image of surroundings of the moving body; an image processing part that processes an image captured by the camera; and a post-processing part that transmits or records an image processed by the image processing part, wherein the image processing part detects personal information contained in an image captured by the camera, and performs image processing for disabling determination of the personal information.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view showing a schematic configuration example of an imaging system according to an embodiment example of the present invention;

FIG. 2 is a block diagram showing a configuration example of an imaging system according to an embodiment example of the present invention;

FIG. 3 is a view showing a list of priority orders during image processing according to an embodiment example of the present invention;

FIG. 4 is a flowchart showing a flow of sequentially performing processing in a plurality of image recognition processing parts, according to an embodiment example of the present invention;

FIG. 5 is a flowchart showing a flow of image processing in a first image recognition processing part, according to an embodiment example of the present invention; and

FIG. 6 is a flowchart showing a flow of image processing in a second image recognition processing part, according to an embodiment example of the present invention.

### DETAILED DESCRIPTION OF EMBODIMENTS

Hereinafter, one or more embodiments of the present invention (hereinafter, referred to as “the present example”) will be described with reference to the drawings. However, the scope of the invention is not limited to the disclosed embodiments.

### System Configuration

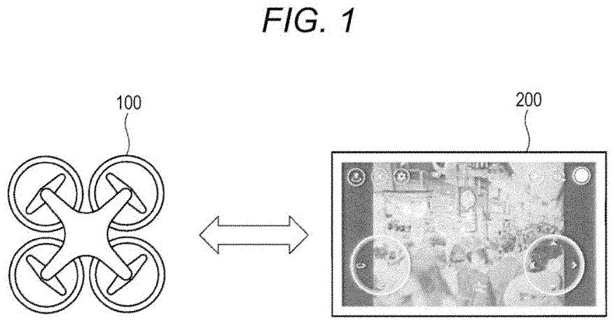

FIG. 1 shows a configuration example of an imaging system of the present example.

The imaging system of the present example includes a drone 100 and a controller 200.

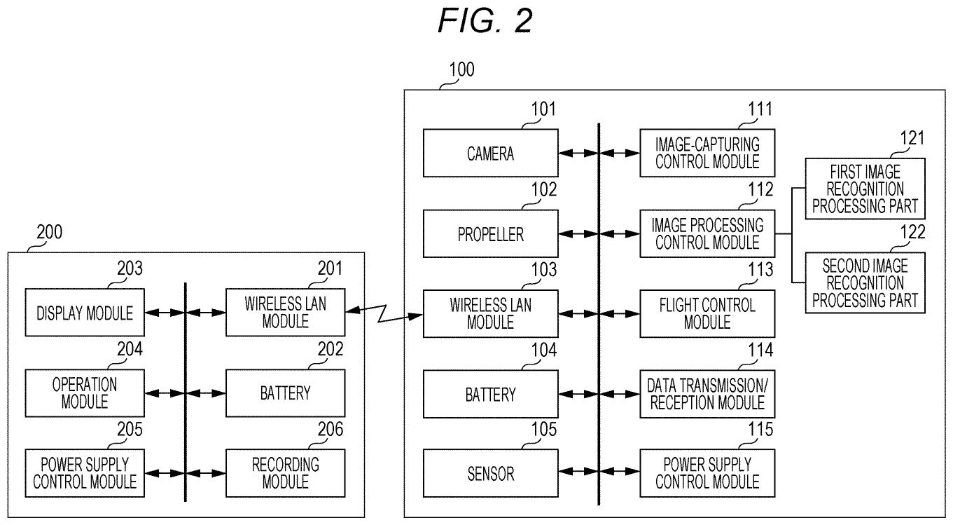

The drone 100 is a flying body that flies with instructions from the controller 200. The drone 100 has a built-in imaging device including a camera 101 (FIG. 2) and the like, and can capture an image of surroundings during flight.

The controller 200 is a terminal that wirelessly communicates with the drone 100, and can instruct the drone 100 of a direction and an altitude of flight. Further, the controller 200 can receive an image signal captured by the drone 100 and display.

### Internal Configuration of Device

FIG. 2 is a block diagram showing an internal configuration example of the drone 100 and the controller 200.

The drone 100 includes the camera 101, a propeller 102, a wireless LAN module 103, a battery 104, and a sensor 105.

Further, the drone 100 includes an image-capturing control module 111, an image processing control module 112, a flight control module 113, a data transmission/reception module 114, a power supply control module 115, a first image recognition processing part 121, and a second image recognition processing part 122.

However, although FIG. 2 shows an example of two of the image recognition processing parts 121 and 122, the number of the image recognition processing parts is one example and is not limited to two.

The camera 101 captures images of surroundings of the drone 100 at a constant frame cycle. Image-capturing with the camera 101 is performed on the basis of instructions from the image-capturing control module 111.

The propeller 102 can rotate on the basis of instructions from the flight control module 113, to cause the drone 100 to fly to the instructed altitude and direction.

The wireless LAN module 103 performs wireless communication with the controller 200, under control of the data transmission/reception module 114. An image signal captured by the camera 101 is wirelessly transmitted to the controller 200 through wireless communication by the wireless LAN module 103.

In addition, the wireless LAN module 103 receives flight instructions such as a flight altitude and direction from the controller 200, and supplies the received flight instruction to the flight control module 113.

When the wireless LAN module 103 receives an image-capturing instruction from the controller 200, the wireless LAN module 103 supplies the received image-capturing instruction to the image-capturing control module 111.

The battery 104 supplies power required to operate each part of the drone 100. The power supply by the battery 104 and management of the remaining battery level are performed by the power supply control module 115.

The sensor 105 detects a flight state of the drone 100, and supplies the detected flight state data to the flight control module 113. For example, the sensor 105 has a function of detecting a flight altitude of the drone 100 from the ground. Further, the sensor 105 may be provided with a positioning unit using global positioning system (GPS) or the like, to have a function of detecting a flight position of the drone 100. When the positioning unit is provided, the sensor 105 may use an altitude (an elevation) obtained by the positioning as a flight altitude.

The image-capturing control module 111 causes the camera 101 to capture an image on the basis of instructions received from the controller 200 through wireless transmission. For example, when receiving instructions such as image-capturing angle and zoom magnification, the image-capturing control module 111 also controls image-capturing with the camera 101 to obtain an image-capturing state based on those instructions.

On the controller 200 side, it is necessary to monitor an image captured by the camera 101 and instruct the flight direction and the like while the drone 100 is in flight. Therefore, the camera 101 constantly captures images while the drone 100 is in flight.

The image processing control module 112 is an image processing part that executes processing (image processing) on an image signal captured and acquired by the camera 101.

When executing image processing, the image processing control module 112 uses the first image recognition processing part 121 and the second image recognition processing part 122 to recognize an object or a person included in each region in the image. Then, the image processing control module 112 executes image processing on the basis of the recognized result, to disable determination of personal information in a part of the region in the image.

When recognizing a person or an object, the image recognition processing parts 121 and 122 perform recognition by, for example, machine learning processing. In addition, each of the image recognition processing parts 121 and 122 may acquire a flight position (an absolute position on a map), a flight altitude, and a camera orientation from the flight control module 113 and the camera 101, and refer to these data to perform recognition. Details of the image processing performed using the image recognition processing parts 121 and 122 will be described later.

Then, the image signal subjected to the image processing by the image processing control module 112 is transmitted to the controller 200 side via the wireless LAN module 103, under control of the data transmission/reception module 114. The data transmission/reception module 114 and the wireless LAN module 103 are post-processing parts for transmission of an image signal subjected to the image processing.

In the case of the present example, the image signal wirelessly transmitted from the wireless LAN module 103 is an image signal processed by the image processing control module 112. However, if the first image recognition processing part 121 or the second image recognition processing part 122 is not able to recognize personal information from the captured image, in other words, if the image does not contain personal information, the image is wirelessly transmitted via the wireless LAN module 103 as it is without the image processing for disabling determination of personal information by the image processing control module 112.

The controller 200 includes a wireless LAN module 201, a battery 202, a display module 203, an operation module 204, a power supply control module 205, and a recording module 206.

The wireless LAN module 201 wirelessly transmits commands such as a flight state and an image-capturing state to the drone 100, and receives an image signal wirelessly transmitted from the drone 100.

The battery 202 supplies power for operating each part of the controller 200, under control of the power supply control module 205.

The display module 203 includes a display part to display an image, displays an image transmitted from the drone 100, and displays information necessary for operating the drone 100.

The operation module 204 is an operation part that accepts user operations for controlling flight of the drone 100. The operation module 204 may be formed with a touch panel incorporated in the display part, to allow operations for flight to be performed by touch operations on the screen.

The recording module 206 records an image transmitted from the drone 100, in a built-in memory or the like.

The controller 200 may be formed as a dedicated device that operates flight of the drone 100. Alternatively, for example, an information processing terminal such as a smartphone or a tablet terminal may be implemented with an application program for functioning as a controller, to be used as a controller for drone control.

### Processing of Captured Images

The image processing control module 112 executes image processing with the first image recognition processing part 121 and the second image recognition processing part 122 for disabling determination of personal information, on the basis of an object and the like recognized from the image captured by the camera 101.

Next, when personal information is determined by the connected image recognition processing parts 121 and 122, this image processing control module 112 executes image processing for disabling determination of the personal information from the captured image, on the basis of a predetermined condition.

Here, the image processing performed by the image processing control module 112 includes, for example, processing for disabling determination of personal information by performing mosaic processing on an equivalent region including personal information to obtain an image whose color and brightness change in a mosaic pattern at regular pixel intervals. However, performing mosaic processing by the image processing control module 112 is an example, and determination of personal information may be disabled by other processing.

The first image recognition processing part 121 and the second image recognition processing part 122 determine each set target object (a specific object or person) as personal information.

Here, the first image recognition processing part 121 determines a person's face included in a captured image as personal information, and performs mosaic processing on the determined face to disable determination of personal information.

In addition, the second image recognition processing part 122 determines a specific target object included in a captured image as personal information.

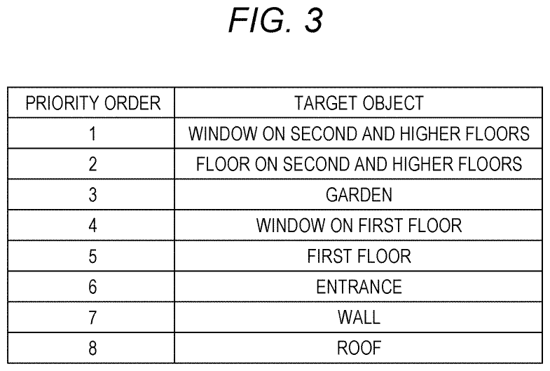

FIG. 3 shows a list of attributes of a target object to be determined as personal information by the second image recognition processing part 122, and an example of setting a priority order for each attribute of the target object.

In the list of the example in FIG. 3, a window on the second and higher floors of a building is set as a target object with the first priority order. Thereafter, in the list in FIG. 3, the entire building on the second and higher floors, a garden, a window on the first floor, the entire building on the first floor, an entrance, a wall, and a roof are set with respective priority orders.

The priority orders in the list shown in FIG. 3 are used for limiting a one-frame image captured by the camera 101 to a maximum range to be subjected to the mosaic processing when the target object is subjected to the mosaic processing.

That is, a value such as 50% is set in the image processing control module 112 as the maximum range for performing mosaic processing.

Then, when performing the mosaic processing, each of the image recognition processing parts 121 and 122 performs the mosaic processing within one frame up to the region of the set maximum value, and is not to perform the mosaic processing even if there is a target object in a range beyond that. This is to avoid a case where it is not possible to determine a flight position and the like from the mosaic-processed image, when transmitting the captured image to the controller 200 side and operating the drone 100 with that image.

In limiting the range of performing the mosaic processing, which target object is to be subjected to the mosaic processing is determined by the priority order given to the list in FIG. 3. That is, each of the image recognition processing part 121 and 122 performs mosaic processing in order from the target object having the highest priority order, and performs no further mosaic processing to the frame when the set value (50%, and the like) is exceeded.

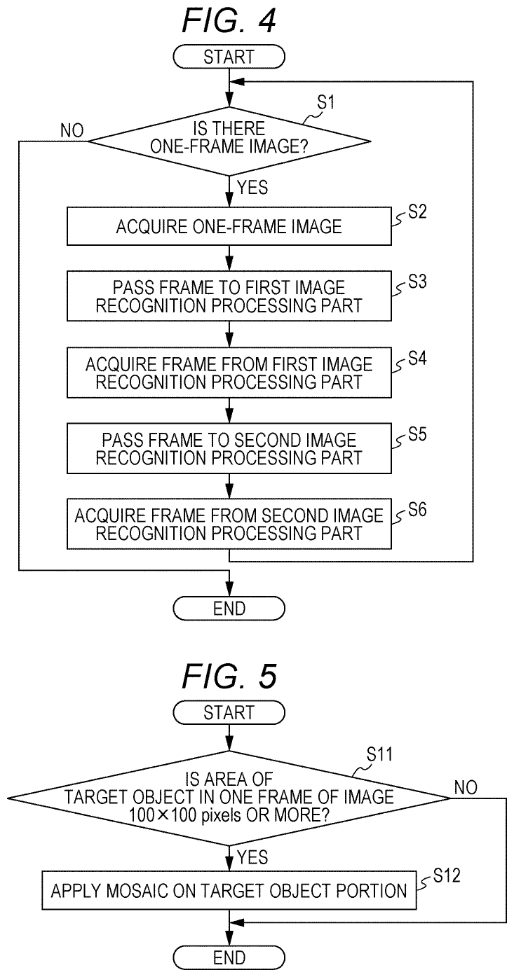

FIG. 4 is a flowchart showing a flow of sequentially performing processing in the image recognition processing parts 121 and 122.

First, the image processing control module 112 determines whether or not a one-frame captured image has been generated by the camera 101 (step S1). When it is determined in step S1 that a one-frame captured image has been generated (YES in step S1), the image processing control module 112 acquires a relevant one-frame image (step S2).

Then, the image processing control module 112 passes the acquired one-frame image to the first image recognition processing part 121 (step S3). The first image recognition processing part 121 performs mosaic processing on a target portion by recognition processing of a person's face, and sends the mosaic-processed one-frame image to the image processing control module 112 (step S4).

After that, the image processing control module 112 passes the one-frame image acquired from the first image recognition processing part 121 to the second image recognition processing part 122 (step S5). When the second image recognition processing part 122 detects a predetermined target object, the second image recognition processing part 122 performs mosaic processing on a relevant portion, and sends the mosaic-processed one-frame image to the image processing control module 112 (step S6).

In this way, the mosaic processing is performed on the one-frame image, and the image processing control module 112 returns to step S1 and waits until the next one-frame image is supplied.

Further, when it is determined in step S1 that a next one-frame captured image is not generated by the camera 101 (NO in step S1), the image processing control module 112 ends the image processing.

FIG. 5 is a flowchart showing a processing example when the first image recognition processing part 121 determines a person's face included in a captured image as personal information.

First, the first image recognition processing part 121 detects a face included in a one-frame image captured by the camera 101 by the face recognition processing, and determines whether or not an area of a target object (the face) in the detected one-frame image is 100 pixels×100 pixels or more (step S11). In this step S11, when the area of the target object is 100 pixels×100 pixels or more (YES in step S11), the first image recognition processing part 121 performs image processing for replacing the portion of the face, which is the target object, with a mosaic (step S12).

In addition, when the area of the target object (the face) is less than 100 pixels×100 pixels even when a face is detected (NO in step S11), the first image recognition processing part 121 does not perform image processing to replace with mosaic.

The first image recognition processing part 121 executes the image processing shown in the flowchart of FIG. 4 for all the frames captured by the camera 101.

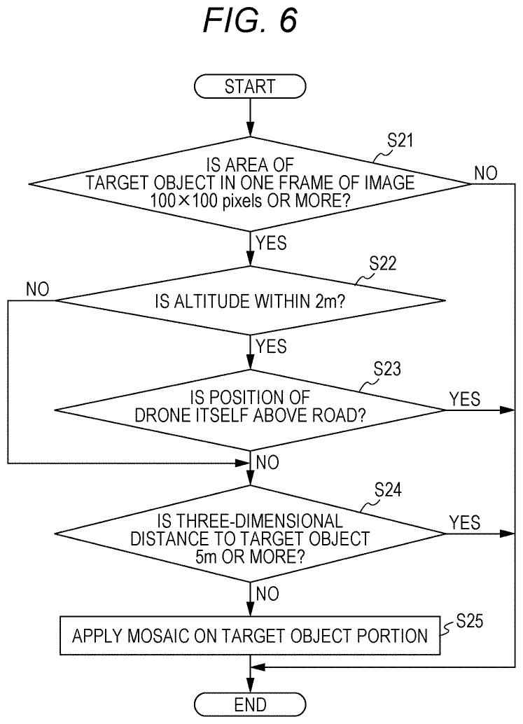

FIG. 6 is a flowchart showing a processing example when the second image recognition processing part 122 determines a target object included in a captured image as personal information.

First, the first image recognition processing part 121 detects a target object included in a one-frame image captured by the camera 101 in the image analysis processing. The target objects to be detected here are those shown in the list in FIG. 3.

Then, the first image recognition processing part 121 determines whether or not an area of the target object in the detected one-frame image is 100 pixels×100 pixels or more (step S21). In this step S21, when the area of the target object in the image is 100 pixels×100 pixels or more (Yes in step S21), the first image recognition processing part 121 acquires current flight altitude data of the drone 100 from the flight control module 113, and determines whether or not the altitude is 2 m or higher (step S22).

When it is determined in step S22 that the flight altitude is 2 m or higher (YES in step S22), the first image recognition processing part 121 determines whether or not a current position of the drone 100 is above a road (step S23). Whether or not the current position of the drone 100 is above a road is determined by the flight control module 113, for example, from map data of the drone 100 and data of a current flight position.

When it is determined in step S23 that the current position of the drone 100 is not above a road (NO in step S23), and when it is determined in step S22 that the flight altitude is less than 2 m (NO in step S22), the second image recognition processing part 122 determines whether or not a three-dimensional distance (a straight line distance) from the target object is 5 m or more (step S24). When it is determined in step S24 that the distance to the target object is not 5 m or more (NO in step S24), the second image recognition processing part 122 performs mosaic processing on a relevant region of the target object (step S25).

Further, when it is determined in step S21 that the area of the target object in the image is not 100 pixels×100 pixels or more (NO in step S21), when it is determined in step S23 that the current position of the drone 100 is above a road (YES in step S23), and when it is determined in step S24 that the distance to the target object is 5 m or more (YES in step S24), the second image recognition processing part 122 ends the processing without performing the mosaic processing on the target object.

When an area within one frame subjected to mosaic processing by the image recognition processing parts 121 and 122 exceeds the above-mentioned set value (50%, and the like), the image recognition processing parts 121 and 122 do not perform any further mosaic processing on the frame at that time.

Since the mosaic processing in the image recognition processing parts 121 and 122 is executed in the order described in FIG. 4, the mosaic processing in the second image recognition processing part 122 is not to be executed, for example, when the mosaic processing has already been performed up to the set value in the mosaic processing by the first image recognition processing part 121.

As described above, an image captured with the camera 101 in the drone 100 is subjected to mosaic processing for disabling determination of personal information by the image processing control module 112, and then transmitted to the controller 200 and displayed on the display module 203 of the controller 200. Further, an image recorded by the recording module 206 of the controller 200 is also an image subjected to mosaic processing.

An operator of the drone 100 is to operate a flight direction and the like of the drone 100 while looking at the image displayed on the display module 203 of the controller 200. At this time, since mosaic processing is applied on a portion of the display image containing personal information such as a person's face or a window of a building, the personal information can be appropriately protected. Further, the recorded image is the same as the image displayed on the controller 200, and it is possible to appropriately protect personal information.

Furthermore, even in case where an image signal wirelessly transmitted from the drone 100 is illicitly received by another device, images containing personal information such as person's faces will not be leaked since the image signal is also made to disable determination of personal information by mosaic processing.

Further, in performing mosaic processing, the processing area within one frame is limited to the set value. Therefore, the operator of the drone 100 can determine a minimum required image content by looking at the image displayed on the display module 203 of the controller 200, which makes it possible to avoid a situation where operation is disabled due to the image processing.

### Modifications

The present invention is not limited to the above-described embodiment example, and can be modified or changed without departing from the gist of the present invention.

For example, the target objects and the priority orders shown in FIG. 3 are examples, and the image processing control module 112 may set other things as a target object for mosaic processing.

For example, the image processing control module 112 may set a nameplate of a house, a license plate of a car, a balcony, a room window that is invisible from a road (ground), things in a private space such as laundry, and a private space itself, as a target object to be mosaic-processed.

Further, in the above-described embodiment example, when the processing area in one frame reaches the set value, the mosaic processing is no longer performed. On the other hand, when the area to be subjected to mosaic processing increases in one frame, the image recognition processing parts 121 and 122 may adopt a low-resolution image with a smaller size of one mosaic in performing mosaic processing. However, even in that case, the operator of the drone 100 requires the image that allows operation of flight somehow.

In addition, the image processing control module 112 may cancel the mosaic processing of a specific portion in an image in response to an instruction from the controller 200. For example, when a specific portion in an image displayed by the display module 203 of the controller 200 is specified by a touch operation of the operator, the image processing control module 112 cancels the mosaic processing of a relevant portion to transmit to the controller 200, and to avoid mosaic processing that interferes with operation.

While the drone 100 wirelessly transmits an image signal subjected to image processing to the controller 200, a recording module may be provided in the drone 100, and the recording module may record the image signal subjected to the image processing.

The drone 100 or the controller 200 may not perform the mosaic processing when receiving some emergency signal from outside.

Further, the image recognition processing parts 121 and 122 may exclude a person or an object registered in advance, from the target objects to be subjected to the mosaic processing.

In the above-described embodiment example, an example has been described in which two image recognition processing parts 121 and 122 are installed. However, a larger number of image recognition processing parts may be installed, and each image recognition processing part may detect a target object in more detail and perform mosaic processing. In this case, the image processing control module 112 may change an algorithm for detecting a target object from an image in a plurality of image recognition processing parts. For example, one specific image recognition processing part may detect a target object from an image by deep learning.

In the above-described embodiment example, an example has been described in which the mosaic processing is performed on a relevant portion, as processing for disabling determination of personal information.

On the other hand, other processing may be performed as processing for disabling determination of personal information. For example, the image processing control module 112 may perform processing to fill a region containing personal information with a single color and the like, wire-frame processing to make an image showing a region containing personal information with a contour line, or processing to animate a region containing personal information. Alternatively, these kinds of processing may be combined.

Further, in the above-described embodiment example, the camera 101 is built in the drone 100. On the other hand, similar processing may be performed even for a camera externally attached to the drone 100.

Furthermore, applying a drone as an application example of the imaging device and the imaging system of the present invention is also an example, and the imaging device and the imaging system of the present invention may be applied to an imaging device or an image-capturing system for other moving body. For example, the present invention may be applied to an imaging device mounted on an automobile, called a dashboard camera.

Although embodiments of the present invention have been described and illustrated in detail, the disclosed embodiments are made for purposes of illustration and example only and not limitation. The scope of the present invention should be interpreted by terms of the appended claims

What is claimed is:

1. An imaging device mounted on or built into a moving body, the imaging device comprising:
a camera that captures an image of surroundings of the moving body;
an image processing part that processes an image captured by the camera; and
a post-processing part that transmits or records an image processed by the image processing part, wherein
the image processing part detects personal information contained in an image captured by the camera, and performs image processing for disabling determination of the personal information.

2. The imaging device according to claim 1, wherein
the image processing for disabling determination of a region containing the personal information is any of mosaic processing, single-color filling processing, wire-frame processing, and animating processing.

3. The imaging device according to claim 1, wherein
the image processing part acquires an attribute of a current position of the moving body, and based on the acquired attribute,
determines a predetermined region in a captured image as a region containing personal information.

4. The imaging device according to claim 1, wherein
the image processing part acquires current height information of the moving body, and determines a predetermined region in a captured image as a region containing personal information, based on the acquired height information.

5. The imaging device according to claim 1, wherein
the image processing part detects a distance to a target object in a captured image, and determines that a predetermined region in the captured image is a region containing personal information, based on the detected distance.

6. The imaging device according to claim 1, wherein
the image processing part limits a region where the image processing is performed in such a way that a ratio of a region subjected to the image processing to an entire screen of an image captured by the camera is equal to or less than a predetermined value set in advance.

7. The imaging device according to claim 6, wherein
when a region where the image processing is performed is limited in such a way that a ratio of a region subjected to the image processing is equal to or less than a predetermined value set in advance, the region to be limited is selected based on a preset priority order of a target object.

8. An imaging system comprising: a moving body having an imaging device that is built-in; and a controller that receives an image signal transmitted from the imaging device, wherein
the imaging device includes:
a camera that captures an image of surroundings of the moving body;
an image processing part that detects personal information contained in an image captured by the camera, and performs image processing for disabling determination of the personal information; and
a transmission processing part that transmits an image processed by the image processing part to the controller, and
the controller includes a display part that receives and displays an image transmitted by the transmission processing part, and
an operation part that operates movement of the moving body.
